(19) United States
(12) Patent Application Publication
(10) Pub. No.: US 2022/0153123 A1
(43) Pub. Date: May 19, 2022

(54) Transmission Assembly, Motor Vehicle Powertrain, and Method for Operating Same

(71) Applicant: ZF Friedrichshafen AG, Friedrichshafen (DE)

(72) Inventors: Stefan Beck, Eriskirch (DE); Fabian Kutter, Kressbronn (DE); Michael Wechs, Weißensberg (DE); Johannes Kaltenbach, Friedrichshafen (DE); Matthias Horn, Tettnang (DE); Peter Ziemer, Tettnang (DE); Thomas Martin, Weissensberg (DE); Oliver Bayer, Hörbranz (AT); Martin Brehmer, Tettnang (DE); Thomas Kroh, Lindau (DE); Max Bachmann, Friedrichshafen (DE)

(21) Appl. No.: 17/435,616

(22) PCT Filed: Oct. 15, 2019
(86) PCT No.: PCT/EP2019/077876

§ 371 Date: Sep. 1, 2021

(30) Foreign Application Priority Data
Mar. 5, 2019 (DE) 10 2019 202 974.4

(51) Int. Cl. B60K 6/547; B60K 6/387; F16H 3/12; F16H 3/089; B60K 6/38

(52) U.S. Cl. CPC B60K 6/547; B60K 6/387; F16H 2200/0047; F16H 3/089; B60K 6/38; F16H 3/12

(57) ABSTRACT

A transmission arrangement (16) for a motor vehicle drive train (10) includes a first input shaft (24) connected or connectable to an internal combustion engine (12), a second input shaft (26) arranged coaxially to the first input shaft (24), an output shaft connected to the first input shaft (24) via a first plurality of engageable first gear-step gear sets (38, 42, 44) and connected to the second input shaft (26) via a second plurality of engageable second gear-step gear sets (36, 52), a first electric machine (56) connected to the second input shaft (26), a second electric machine (60) connected to the first input shaft (24), and a first clutch (K1) via which the first input shaft (24) and the second input shaft (26) are connectable to each other. The second gear-step gear sets include two alternately engageable gear-step gear sets (36, 52), via each of which an electric motor-driven operation is establishable by the first electric machine (56). The transmission arrangement (16) is configured such that an internal combustion engine-driven operation is establishable via one (36) of the two alternately engageable gear-step gear sets (36, 52) when the first clutch (K1) is engaged.

### CROSS-REFERENCE TO RELATED APPLICATIONS

The present application is related and has right of priority to German Patent Application No. 102019202974.4 filed in the German Patent Office on Mar. 5, 2019 and is a nationalization of PCT/EP2019/077876 filed in the European Patent Office on Oct. 15, 2019, both of which are incorporated by reference in their entirety for all purposes.

### FIELD OF THE INVENTION

The present invention relates generally to a transmission arrangement for a motor vehicle drive train, with a first input shaft connected or connectable to an internal combustion engine, a second input shaft arranged coaxially to the first input shaft, an output shaft connected to the first input shaft via a first plurality of engageable first gear-step gear sets and connected to the second input shaft via a second plurality of engageable second gear-step gear sets, a first electric machine connected to the second input shaft, a second electric machine connected to the first input shaft, and a first clutch, via which the first input shaft and the second input shaft are connectable to each other.

The present invention further relates generally to a drive train for a motor vehicle, with an internal combustion engine and a transmission arrangement of the aforementioned type.

Finally, the present invention relates generally to a method for operating a drive train of this type.

### BACKGROUND

A transmission arrangement of the above-described type is known from document DE 10 2011 005 451 A1. The hybrid drive disclosed therein includes an automated transmission with two input shafts and a shared output shaft. The first input shaft is connectable via a separating clutch to the drive shaft of an internal combustion engine. The first input shaft is bringable into a drive connection with the output shaft via a first group of selectively engageable gear-step gear sets. The second input shaft is drivingly connected to the rotor of an electric machine operable as a motor and as a generator. The second input shaft is bringable into a drive connection with the output shaft via a second group of selectively engageable gear-step gear sets. The input shafts are coupleable to each other via an engageable and disengageable coupling shift element. In order to improve the operating property, a second electric machine operable as a motor and as a generator is provided, the rotor of which is drivingly connected to the first input shaft.

Moreover, document DE 10 2010 030 573 A1 discloses a hybrid drive with an automated transmission.

Finally, document US 2017/0129323 A1 discloses a hybrid transmission for a motor vehicle with an internal combustion engine and an electric main prime mover. The transmission includes two concentric input shafts, which are connected to a crankshaft of the internal combustion engine and to the electric machine without a separating clutch. The transmission includes, furthermore, an output shaft and a shaft for transmitting turning motions of an input shaft to the output shaft and for coupling the input shafts. The electric machine is arranged at an end opposite the input shafts in relation to the internal combustion engine.

Provided that transmission arrangements for motor vehicle drive trains are designed for the front or the rear transverse installation in a motor vehicle, attention is paid, in particular, to a short axial installation length. In the case of transmissions for a longitudinal installation, attention is paid, in particular, to a radially compact design.

In front-mounted and rear-mounted transverse transmissions, two countershafts arranged axially parallel are frequently associated with an input shaft arrangement, and so the power flow can take place from the input shaft arrangement either via one countershaft or via the other countershaft. The countershafts are also designed as output shafts and, in general, are both in engagement with a differential for distributing input power to driven wheels.

A further trend in the field of motor vehicle drive trains is hybridization. In general, this means that an electric machine, as a further prime mover, is associated with a prime mover in the form of an internal combustion engine. Here, a distinction is made between a plurality of different concepts, which each provide a different connection of the electric machine to the transmission. In many cases, an electric machine is arranged concentrically to an input element of a clutch assembly. In order to be able to utilize the electric machine, in this case, not only for assisting the internal combustion engine, but rather also to be able to set up a purely electric motor-driven operation, the input element of the clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

### SUMMARY OF THE INVENTION

Example aspects of the invention provide an improved transmission arrangement for a motor vehicle drive train, an improved drive train for a motor vehicle, and an improved method for operating a drive train of this type.

Example aspects of the invention provide a transmission arrangement for a motor vehicle drive train, with: a first input shaft connected or connectable to an internal combustion engine; a second input shaft arranged coaxially to the first input shaft; an output shaft connected to the first input shaft via a first plurality of engageable first gear-step gear sets and is connected to the second input shaft via a second plurality of engageable second gear-step gear sets; a first electric machine connected to the second input shaft; a second electric machine connected to the first input shaft; and a first clutch, via which the first input shaft and the second input shaft are connectable to each other. The second gear-step gear sets include two alternately engageable gear-step gear sets, via each of which an electric motor-driven operation is establishable by the first electric machine. The transmission arrangement is designed in such a way that an internal combustion engine-driven operation is establishable via one of the two alternately engageable gear-step gear sets when the first clutch is engaged.

Moreover, example aspects of the invention provide a drive train for a motor vehicle, with an internal combustion engine and with a transmission arrangement of the type according to example aspects of the invention, wherein the first input shaft is rotationally fixed to the internal combustion engine or wherein the first input shaft is connected to the internal combustion engine via a separating clutch.

Finally, example aspects of the invention provide a method for operating a drive train of the type according to example aspects of the invention, which, starting from a purely electric operation or a hybrid operation via the one of the two alternately engageable second gear-step gear sets, wherein the first clutch is engaged, wherein the internal combustion engine is rotationally fixed to the first input shaft and wherein a gearshift clutch associated with the one gear-step gear set is engaged, includes the following: reducing load at the first clutch and building up load at the first electric machine, disengaging the first clutch, reducing the rotational speed of the first input shaft until a further gearshift clutch, which is associated with one of the first gear-step gear sets, is synchronized, and engaging the further gearshift clutch.

The transmission arrangement according to example aspects of the invention can be implemented in a radially and axially compact manner. Moreover, the transmission arrangement can be implemented with low design complexity.

The transmission arrangement is designed in such a way that an internal combustion engine-driven operation, with the first clutch engaged, is preferably establishable only via one of the two alternately engageable second gear-step gear sets. An example design of the transmission arrangement in this way can take place, in particular, in such a way that a control device of the transmission arrangement is programmed in such a way that the other of the two alternately engageable second gear-step gear sets is not utilized in a purely internal combustion engine-drive operation or a hybrid operation, in which internal combustion engine-generated input power as well as electric motor-generated input power is provided, i.e., the associated gearshift clutch is not engaged.

In fact, this means that a gear set plane is not available for the internal combustion engine-driven operation. On the other hand, this other gear set plane can be specifically optimized for a purely electric motor-driven operation. Via the one of the two alternately engageable second gear-step gear sets, therefore, in the transmission arrangement according to example aspects of the invention, only electric motor-generated power is transmitted and, in fact, input power from the first electric machine. In a hybrid operation, in addition, electric motor-generated input power can be transmitted via this one of the two alternately engageable second gear-step gear sets, while internal combustion engine-generated power is transmitted via one of the first gear-step gear sets (and, if necessary, electric motor-generated power of the second electric machine via one of the first gear-step gear sets). The power summation then takes place in the output shaft.

The gear step that is associated with the other of the two alternately engageable second gear-step gear sets is preferably a gear step for relatively high ground speeds, for example, for ground speeds of greater than fifty kilometers per hour (>50 km/h), in particular greater than sixty kilometers per hour (>60 km/h) and, in particular greater than or equal to approximately seventy kilometers per hour approximately 70 km/h).

The transmission arrangement preferably includes, as described above, a control device, by which the shift elements, such as clutches, gearshift clutches, etc., can be actuated in an automated manner. The actuation takes place via suitable actuators, which can be designed to be electric motor-operated, hydraulic, electrohydraulic, or electromagnetic.

Moreover, the control device can be configured for actuating the electric machines and, in fact, in such a way that the electric machines can both operate as a motor and as a generator. Moreover, the control device can be designed for interacting with an engine control unit of the internal combustion engine, in order to be able to operate the drive train in a coordinated manner.

The second input shaft is preferably a hollow shaft, which is arranged around the first input shaft. The engageable first gear-step gear sets preferably form a first sub-transmission of the transmission arrangement. The engageable second gear-step gear sets preferably form a second sub-transmission of the transmission arrangement.

The transmission arrangement preferably includes only the coaxial input shaft arrangement with the first input shaft and the second input shaft as well as the output shaft, i.e., can be radially particularly compact. The output shaft is preferably connected to an output gear set for driving a power distribution unit.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains.

A regular forward gear step, i.e., a fixed ratio, is preferably associated with each gear-step gear set. The transmission arrangement preferably does not include a gear set, with which a reverse gear step is associated. Travel in reverse is preferably implemented exclusively via one of the electric machines.

The first clutch, which can connect the first input shaft and the second input shaft to each other, is not a clutch of the type that is utilized for establishing a winding-path gear step in the transmission arrangement. This is the case because, during the establishment of a winding-path gear step, two gear sets of each of the two sub-transmissions are generally involved, in order to implement a ratio that is as low as possible or a ratio that is as high as possible, i.e., in order to allow for a high spread of gear ratios of the transmission arrangement. In the present case, however, power is preferably always transmitted only via one gear-step gear set from one of the input shafts to the output shaft, and so the spread of gear ratios of the transmission arrangement preferably results exclusively due to the ratios of the regular forward gear steps. Consequently, the transmission arrangement can generally operate with a high efficiency.

The transmission arrangement is preferably not connected to a dual clutch on the input side. In other words, in the present transmission arrangement, the second input shaft is connectable to an internal combustion engine exclusively via the first clutch. Consequently, the transmission arrangement can be implemented without a complex input-side clutch assembly.

The assignment of gear steps to the two sub-transmissions, therefore, in the present case, is not necessarily in such a way that one sub-transmission is associated with even gear steps and another sub-transmission is associated with odd gear steps. Rather, the gear steps of both sub-transmissions can each include consecutive gear steps, for example, second, third, and fourth forward gear steps (2, 3, 4) in the first sub-transmission and/or first and second electric gear steps (E1.1 and E1.2) in the second sub-transmission.

In the present case, a connection is understood to mean, in particular, that the two elements to be connected to each other are permanently connected to each other in a rotationally fixed manner. Alternatively, however, the two elements can be connected to each other in a rotationally fixed manner as necessary. In the present case, a rotationally fixed connection is understood to mean that the elements connected in this way rotate at a rotational speed proportional to each other.

The electric machines can be arranged coaxially to the input shafts. Preferably, however, the electric machines are arranged axially parallel to the transmission arrangement. Consequently, the longitudinal axes of the electric machines are preferably aligned in parallel, although offset with respect to the input shafts as well as to the output shaft.

The control device of the transmission arrangement is preferably configured for establishing at least the following operating modes: a purely internal combustion engine-driven operation; a purely electric operation by the first electric machine; and a purely electric operation by the second electric machine.

Moreover, the control device is configured for establishing a hybrid operation, in which input power is provided by the internal combustion engine and electric motor-generated input power is provided by the first electric machine and/or the second electric machine. The hybrid traveling mode can be a drive mode, although the hybrid traveling mode can also be a mode, in which mechanical input power is at least partially supplied to the electric machines, in order to operate the electric machines as generators for charging a vehicle battery.

Moreover, the hybrid drive train is preferably configured for carrying out a sailing operation, in which, starting from a moderate or high ground speed, the internal combustion engine is decoupled and the ground speed is maintained, for example, by an intermittent operation of one or both electric machine(s). Stationary charging is also possible.

Moreover, a crawling mode is possible, in particular for the case in which a serial operation is established. In the present case, a serial operation is understood to mean that, in a purely electric motor-driven operation by the first electric machine, the second electric machine is simultaneously driven by the internal combustion engine and operated as a generator, in order to charge a vehicle battery. The vehicle battery is preferably the same battery from which the electric machine operating as a motor withdraws power. In a crawler gear, the ground speed of the vehicle is generally below a speed, at which the internal combustion engine can be utilized as a prime mover (due to the ratio of the lowest gear step or starting gear step). In order to also be able to permanently establish a low ground speed of this type beyond the maximum capacity of the vehicle battery, the above-described serial operation can be implemented.

In addition, with the transmission arrangement according to example aspects of the invention, it is possible to utilize an electric machine for synchronization during gear changes in an internal combustion engine-driven operation or a hybrid operation, i.e., to assist the internal combustion engine during synchronization by an electric machine. In the internal combustion engine-driven operation or in the hybrid operation, the second electric machine is continuously connected to the internal combustion engine. As a result, a load-point displacement at the internal combustion engine is also possible and the second electric machine can assist during the closed-loop control of the rotational speed when a shift element, such as a gearshift clutch, must be synchronized.

Due to the fact that an electric machine is associated with each of the two sub-transmissions, it is also preferably possible to carry out all gear changes as powershifts, and so an interruption of tractive force does not take place. In this connection, an interruption of tractive force is provided by the first electric machine, for example, during a gear change in the first sub-transmission. During a gear change within the second sub-transmission, an interruption of tractive force can be provided by the second electric machine.

Preferably, the first clutch is engaged only for the case in which internal combustion engine-generated power and/or power from the second electric machine is to be transmitted via the one of the two alternately engageable gear-step gear sets. In other words, the first clutch is engaged in an internal combustion engine-driven operation only for an internal-combustion-engine gear step. The first clutch preferably remains disengaged in all other gear steps in the internal combustion engine-driven operation. In other words, the first electric machine can be decoupled when the internal combustion engine utilizes one of the gear steps of the first sub-transmission. In this way, an efficient internal combustion engine-driven operation is possible. The second electric machine can be dimensioned smaller, if necessary, than the first electric machine, since the second electric machine preferably does not need to perform essential driving functions.

According to one preferred example embodiment, the first input shaft is connected to the output shaft via three engageable first gear-step gear sets.

Preferably, the first sub-transmission includes precisely those three engageable first gear-step gear sets. The three engageable first gear-step gear sets are preferably associated with gear steps that are adjacent to one another, preferably the second, third, and fourth gear steps (2, 3, and 4).

According to one further preferred example embodiment, the two alternately engageable second gear-step gear sets include a gear-step gear set for a starting gear step, via which the internal combustion engine-driven operation is establishable.

Preferably, a pulling away from rest always takes place by the first electric machine. As soon as a speed has been reached that corresponds to a rotational speed of the internal combustion engine, at which the internal combustion engine can provide a drive torque, the internal combustion engine can be engaged (by engaging the first clutch). Thereafter, internal combustion engine-generated power can be transmitted in the first forward gear step (starting gear step).

Moreover, the starting gear step can be utilized by the first electric machine for speed ranges that extend from zero kilometers per hour (0 km/h) to fifty kilometers per hour (50 km/h), preferably from zero kilometers per hour (0 km/h) to sixty kilometers per hour (60 km/h), preferably from zero kilometers per hour (0 km/h) to approximately seventy kilometers per hour (70 km/h), to mention a few examples.

For higher ground speeds, the other engageable second gear-step gear set is then engaged into the power flow when travel is to take place in a purely electric motor-driven manner via the first electric machine.

According to one further preferred example embodiment, the other of the two alternately engageable second gear-step gear sets is associated with a second electric gear step, the ratio of which is smaller than the largest ratio of the first gear-step gear sets and is larger than the smallest ratio of the first gear-step gear sets.

Consequently, the ratio of this other gear-step gear set can be optimized for the purely electric operation at higher speeds.

The ratio is not necessary for an internal combustion engine-driven operation, however, since this ratio is already covered by the first gear-step gear sets.

Overall, it is advantageous, furthermore, when the first clutch is arranged in the axial direction between the first gear-step gear sets and the second gear-step gear sets.

Due to this example arrangement between the two sub-transmissions, the input shafts can be connected to each other in a structurally favorable manner.

Moreover, it is preferred overall when the first clutch and a gearshift clutch for engaging one of the first gear-step gear sets form a first gearshift clutch assembly, which is actuatable by a single actuating unit.

In this way, the transmission arrangement can be implemented with a small number of actuating units.

In general, a gearshift clutch assembly is understood to be an arrangement formed from two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type can also be referred to as a double shift element.

A gearshift clutch is understood, in the present case, to be a form-lockingly connecting clutch, which, in general, can be synchronized or non-synchronized. As explained in greater detail below, the gearshift clutches in the present case are preferably not all synchronized, but rather are designed as pure dog clutches.

Overall, it is advantageous, furthermore, when two gearshift clutches for the alternate engagement of two first gear-step gear sets form a second gearshift clutch assembly.

It is also advantageous when two gearshift clutches for the alternate engagement of two second gear-step gear sets form a third gearshift clutch assembly.

The second gearshift clutch assembly and the third gearshift clutch assembly are each actuatable by a single associated actuating unit.

Preferably, the first gearshift clutch assembly is arranged in the axial direction between the first sub-transmission and the second sub-transmission. Preferably, furthermore, the second gearshift clutch assembly is arranged in the axial direction between the two associated first gear-step gear sets, which are preferably associated with the second and fourth or third and fourth forward gear steps (2 and 4 or 3 and 4). Preferably, the third gearshift clutch assembly is arranged in the axial direction between the two second gear-step gear sets.

The first gearshift clutch assembly is preferably arranged coaxially to the first input shaft. The second gearshift clutch assembly and the third gearshift clutch assembly are preferably arranged coaxially to the output shaft, although the second gearshift clutch assembly and the third gearshift clutch assembly can also be arranged coaxially to the input shafts.

Moreover, it is advantageous overall when the transmission arrangement includes the following, axially one after the other starting from one axial end: (i) gear set plane for a second gear step usable by an electric motor, (ii) gearshift clutch plane for a third gearshift clutch assembly, (iii) gear set plane for a first gear step, (iv) gearshift clutch plane for a first gearshift clutch assembly, which includes the first clutch, (v) gear set plane for a third gear step or for a second gear step, (vi) gear set plane for a second gear step or a third gear step, (vii) gearshift clutch plane for a second gearshift clutch assembly, and (viii) gear set plane for a fourth gear step.

Overall, a compact and simple transmission arrangement is implemented in this way.

Advantageously, the transmission arrangement includes an output gear set at one axial end, by which the output shaft is connected to a power distribution unit such as a mechanical differential for driven wheels.

In this example embodiment, the output gear set can be axially aligned with a separating clutch, which, in one preferred example embodiment, can connect the first input shaft and an internal combustion engine.

Provided that the electric machines are arranged axially parallel to the input shafts and to the output shaft, a connection can take place via spur gear trains or flexible traction drive mechanisms. For this purpose, a separate gearwheel can be associated with each of the particular sub-transmissions.

It is particularly preferred, however, when the first electric machine is connected to the second input shaft via one of the second gear-step gear sets and/or when the second electric machine is connected to the first input shaft via one of the first gear-step gear sets.

In this example embodiment, a separate fixed gear at an input shaft for the connection of an electric machine is not necessary.

The connection can be such that a pinion of the particular electric machine is in direct engagement with a fixed gear of the particular gear-step gear set. It is preferred, however, when at least one of the electric machines is connected, with the machine pinion via an intermediate gear, to the fixed gear of the associated gear-step gear set.

It is particularly advantageous here when the second gear-step gear set, via which the first electric machine is connected to the second input shaft, is arranged in the area of a first axial end of the transmission arrangement, and/or when the first gear-step gear set, via which the second electric machine is connected to the first input shaft, is arranged in the area of a second axial end of the transmission arrangement.

As a result, it is possible to arrange the electric machines largely in overlap with each other in the axial direction. Moreover, this allows for a connection of the particular electric machine at a point, at which high bearing forces can be absorbed. This is the case because housing walls or bearing plates are generally arranged at the axial ends of the transmission arrangement.

Moreover, it is advantageous when the second gear-step gear set, via which the first electric machine is connected to the second input shaft, is associated with the highest gear step that is establishable by the second gear-step gear sets, and/or when the first gear-step gear set, via which the second electric machine is connected to the first input shaft, is associated with the highest gear step that is establishable by the first gear-step gear sets.

In the example embodiment, in which the first input shaft is rotationally fixed to the internal combustion engine, the drive train according to example aspects of the invention is preferably actuatable only by three actuating units, which are associated with the aforementioned three gearshift clutch assemblies. Provided that a separating clutch is arranged between the first input shaft and the internal combustion engine, a separate (fourth) actuating unit is to be provided for the separating clutch.

The separating clutch can be preferably arranged in an axial plane with an output gear set, as described above. The separating clutch can be implemented as a form-locking gearshift clutch, in particular as a dog clutch. The gearshift clutch can also be designed as a friction clutch, however, which is preferably normally disengaged.

The advantage of the latter example variant is that a friction clutch can also disengage under load, for example, in the case of a full brake application or a malfunction in the internal combustion engine.

In this case, the separating clutch can also be engaged at a differential speed, and so a flywheel start of the internal combustion engine is possible by the second electric machine. In such a flywheel start, the inertial mass of the second electric machine is utilized for the internal combustion engine start.

A plurality of traveling modes is possible with the drive train according to example aspects of the invention and the transmission arrangement according to example aspects of the invention.

For example, the internal-combustion-engine gear steps, which are establishable by the first gear sets as well as the one gear set of the second gear sets, as well as electric gear steps are usable by the second electric machine when a separating clutch K0 is present and is disengaged. Here, travel can then take place purely electrically with both electric machines. In the purely electric mode, powershifts are then possible, in that the first electric machine supports the tractive force when a gear change is carried out during the drive of the second electric machine, and vice versa.

In the internal combustion engine-driven mode, the separating clutch always remains engaged, provided it is present. In this way, the internal combustion engine is always connected to the second electric machine.

The second electric machine can implement the following functions and, in fact, also for the case in which a separating clutch is not present: a start of the internal combustion engine from a purely electric driving operation; a supply of the main power circuit; a serial creeping and traveling forward/in reverse; and a support of a closed-loop control of the rotational speed of the internal combustion engine during coupling and during gear shifts. The internal combustion engine can be coupled in all gear steps (e.g., 1, 2, 3, 4) when the first electric machine utilizes the one gear-step gear set of the second gear-step gear sets. When the first electric machine utilizes the other gear-step gear set of the second gear-step gear sets, the internal combustion engine can be coupled at the gears (e.g., 2, 3, 4) of the first sub-transmission.

The second electric machine can provide support during the unloading of the first clutch and of the gearshift clutches of the first sub-transmission when the second electric machine operates as a generator. The current generated in this way can then be utilized by the first electric machine to support tractive force.

The following functions can be performed by the first electric machine and, in fact, also for the case in which a separating clutch is not present: an electric vehicle drive for pulling away from rest and traveling forward/in reverse; a support of the tractive force during internal-combustion-engine gear shifts; and, when a changeover takes place at the first clutch or at one of the gearshift clutches of the first sub-transmission, the first electric machine can maintain the tractive force via the associated gear-step gear sets of the second sub-transmission.

The first electric machine can be connected to the internal combustion engine via the first clutch. In this way, the first electric machine can also start the internal combustion engine and act as a generator for generating power for a consumer, for example, when the vehicle is at a standstill.

In the method according to example aspects of the invention, a powershift can take place, for example, from the first gear step into the second gear step in the hybrid operation. This also applies for the example variant without a separating clutch.

In the step of the method according to example aspects of the invention, in which the rotational speed of the first input shaft is reduced, this can take place, in that the rotational speed of the internal combustion engine and/or of the second electric machine is reduced. For this purpose, the second electric machine can operate, for example, as a generator, or the internal combustion engine can transition into the coasting condition.

When the first clutch is disengaged, it is possible to change over, without load, from the first electric gear step (established via the one gear-step gear set of the second gear-step gear sets) into the second electric gear step. In so doing, the rotational speed of the first electric machine is reduced. The changeover then takes place while the internal combustion engine (and/or the second electric machine) maintains the tractive force in one of the gears of the first sub-transmission.

Overall, the transmission arrangement yields at least one of the following advantages: a simple configuration; a compact design; low component loads; low transmission losses; a good gearing efficiency; a good transmission ratio range; and only three or four actuating units or actuators.

Provided that the internal combustion engine is directly connected to the first input shaft (without a separating clutch), a purely electric operation by the second electric machine is not possible; otherwise the internal combustion engine would have to be entrained. Purely electric powershifts are also possibly not necessary or useful in this case.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein

FIG. 1 shows a schematic of an example embodiment of a drive train according to the invention with a transmission arrangement according to example aspects of the invention;

FIG. 2 shows a gearshift table for forward gear steps V1 through V4 in an internal combustion engine-driven operation or a hybrid operation by the drive train from FIG. 1;

FIG. 3 shows a gearshift table for two gear steps E1.1 and E1.2 in a purely electric motor-driven operation by the drive train from FIG. 1;

FIG. 4 shows a schematic of a further example embodiment of a drive train;

FIG. 5 shows a schematic of a further example embodiment of a drive train;

FIG. 6 shows a schematic of a further example embodiment of a drive train; and

FIG. 7 shows a schematic of a further example embodiment of a drive train.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

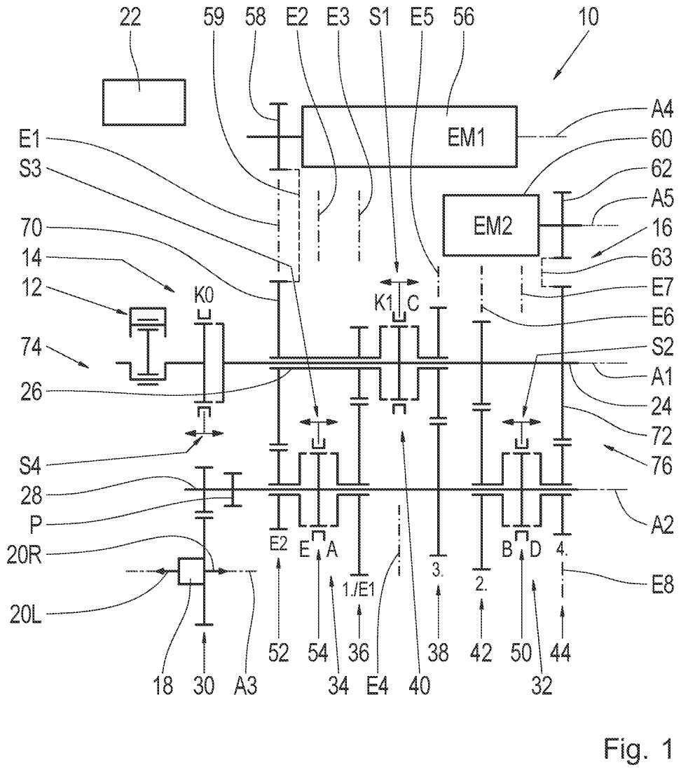

In FIG. 1, a drive train in the form of a hybrid drive train is diagrammatically represented in diagrammatic form and is labeled, in general, with 10.

The drive train 10 includes an internal combustion engine 12. Moreover, the drive train 10 includes a clutch assembly 14, which is connected on the input side to the internal combustion engine 12. On the output side, the clutch assembly 14 is connected to a hybrid transmission arrangement 16. An output of the transmission arrangement 16 is connected to a power distribution unit 18, which can be formed, for example, by a mechanical differential. The power distribution unit 18 distributes input power to driven wheels 20L, 20R.

The drive train 10 is designed for installation transversely in a motor vehicle, for example, in the front or in the rear of a motor vehicle.

Moreover, the drive train 10 includes a control device 22, by which the shift elements of the drive train 10 and/or electric machines of the drive train 10 and/or an internal combustion engine of the drive train 10 are actuatable.

The transmission arrangement 16 includes a first input shaft 24 and a second input shaft 26. The first input shaft 24 is connected to an output element of the clutch assembly 14. The clutch assembly 14 includes, in the present case, a single clutch in the form of a separating clutch K0. The separating clutch K0 can be implemented as a dog clutch. The first input shaft 24 is situated on a first axis A1. The second input shaft 26 is arranged, as a hollow shaft, coaxially around the first input shaft 24.

The transmission arrangement 16 includes, furthermore, an output shaft 28, which is arranged axially parallel to the input shafts 24, 26 and, in fact, on a second axis A2.

The output shaft 28 is rotationally fixed to the power distribution unit 18 via an output gear set 30, wherein the power distribution unit 18 is situated on a third axis A3.

The transmission arrangement 16 includes a first sub-transmission 32, which is associated with the first input shaft 24. Moreover, the transmission arrangement 16 includes a second sub-transmission 34, which is associated with the second input shaft 26. The first sub-transmission 32 includes a plurality of engageable first gear-step gear sets. The second sub-transmission includes a second plurality of engageable second gear-step gear sets.

The second sub-transmission 34 includes a gear set 36, which is associated with a first forward gear step 1 for an internal combustion engine-driven operation and a gear step E1 (E1.1) for an electric motor-driven operation. The first sub-transmission 32 includes a gear set 38, which is associated with a third forward gear step 3.

A first gearshift clutch assembly 40 is arranged between the gear sets 36, 38. The first gearshift clutch assembly 40 includes a first clutch K1, by which the first input shaft 24 and the second input shaft 26 are connectable to each other in a rotationally fixed manner. Moreover, the first gearshift clutch assembly 40 includes a gearshift clutch C, which is associated with the gear set 38 for the forward gear step 3. The first gearshift clutch assembly 40 is actuatable by a single actuating unit S1 and can control either the first clutch K1 or the gearshift clutch C or establish a neutral position.

The first sub-transmission 32, furthermore, includes a gear set 42 for a second forward gear step 2 and includes a gear set 44 for a fourth forward gear step 4.

Between the gear sets 42, 44, the transmission arrangement 16 includes a second gearshift clutch assembly 50, which is arranged coaxially to the second axis A2. The second gearshift clutch assembly 50 includes a gearshift clutch B, which is associated with the gear set 42, and a gearshift clutch D, which is associated with the gear set 44. The second gearshift clutch assembly 50 is actuatable by a single actuating unit S2, wherein either the gearshift clutch B or the gearshift clutch D can be engaged, or a neutral position can be established.

The second sub-transmission 34 includes, in addition to the gear set 36 for the forward gear step 1, a gear set 52, which is associated with a second electric gear step E2 (E1.2).

Moreover, the transmission arrangement 16 includes a third gearshift clutch assembly 54, which is arranged on the second axis A2 and includes a gearshift clutch E for the gear set 52 and a gearshift clutch A for the gear set 36. The third gearshift clutch assembly 54 is actuatable by a third actuating unit S3, and so either the gearshift clutch E for engaging the gear set 52 or the gearshift clutch A for engaging the gear set 36 is engaged. Moreover, a neutral position can be established therebetween.

A parking interlock gear P can be rotationally fixed at the output shaft 28, in order to be able to immobilize a vehicle equipped with the drive train 10. An associated parking lock device is not represented in FIG. 1 for the sake of clarity.

The gear set 52 is arranged in a gear set plane E1, which is axially adjacent to the clutch assembly 14. On the axially opposite side, the third gearshift clutch assembly 54 is arranged in a clutch plane E2. Next thereto, the gear set 36 is arranged in a gear set plane E3. Next thereto, the first gearshift clutch assembly 40 is arranged in a clutch plane E4. Next thereto, the gear set 38 is arranged in a gear set plane E5. Next thereto, the gear set 42 is arranged in a gear set plane E6. Next thereto, the second gearshift clutch assembly 50 is arranged in a clutch plane E7. The gear set 44 is arranged in a gear set plane E8, which is situated at an end of the transmission arrangement 16 opposite the clutch assembly 14.

The transmission arrangement 16 includes a first electric machine 56, which is arranged coaxially to a fourth axis A4. The first electric machine 56 includes a first pinion (first machine pinion) 58, which is connected to the gear set 52 via an intermediate gear 59 for rotational-speed adaptation. The first electric machine 56 is therefore rotationally fixed to the fixed gear of the gear set 52, wherein the fixed gear of the gear set 52 forms a first gearwheel 70.

The transmission arrangement 16 includes, furthermore, a second electric machine 60, which is arranged on a fifth axis A5. The second electric machine 60 includes a second pinion 62, which is in engagement with the gear set 44 via a second intermediate gear 63. More precisely, the second intermediate gear 63 is in engagement with a second gearwheel (second machine gearwheel) 72, which is formed by the fixed gear of the gear set 44 fixed at the first input shaft 24.

The first gearwheel 70 (first machine gearwheel) is a fixed gear of the gear set 52 fixed at the second input shaft 26.

The transmission arrangement 16 includes a first axial end 74 and a second axial end 76. The internal combustion engine 12 and the clutch assembly 14 are arranged in an area of the first axial end. Of all gear sets of the transmission arrangement 16, the gear set 52 is arranged closest to the first axial end 74. Of all gear sets, the gear set 44 of the first sub-transmission 32 is arranged closest to the second axial end.

The electric machines 56, 60 overlap in the axial direction and preferably extend between the axial ends 74, 76.

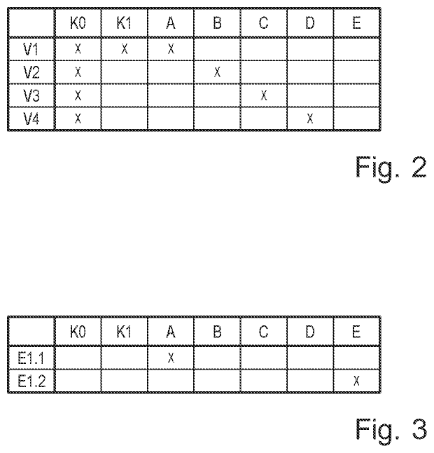

By the drive train 10, the following operations represented in FIGS. 2 and 3 are implementable.

According to the gearshift table from FIG. 2, four internal-combustion-engine gear steps V1 through V4 are establishable. In all of them, the separating clutch K0 of the clutch assembly 14 is engaged (X in FIG. 2). Moreover, in the first forward gear step V1, the first clutch K1 is engaged and the gearshift clutch A of the gear set 36 is engaged.

Consequently, input power of the internal combustion engine 12 flows via the engaged separating clutch K0 onto the first input shaft 24 and, from there, via the first clutch K1 onto the second input shaft 26. Due to the engaged gearshift clutch A, the power flows via the gear set 36 onto the output shaft 28 and, from there, toward the power distribution unit 18.

In order to establish the second forward gear step V2, the first clutch K1 and the gearshift clutch A are disengaged and the gearshift clutch B is engaged. In this case, input power flows from the internal combustion engine 12 via the separating clutch K0 and the first input shaft 24 into the gear set 42 and, from there, into the output shaft 28. The other forward gear steps V3 and V4 result in a corresponding way, wherein, here, only one gearshift clutch is engaged in each case, namely either the gearshift clutch C or the gearshift clutch D.

The gearshift clutch E is never engaged in the internal combustion engine-driven operation, and so an internal combustion engine-driven operation is establishable when the first clutch K1 is engaged only via the gear set 36 of the second sub-transmission 34, and not via the gear set 52 of the second sub-transmission 34.

The forward gear steps represented in FIG. 2 are also implementable in a hybrid operation, in which internal combustion engine-generated power and electric motor-generated power from the second electric machine 60 are delivered into the first input shaft. Here, the second electric machine 60 can also operate as a generator, if necessary.

Moreover, in parallel thereto, the first electric machine 56 can provide input power via the second sub-transmission 34. Provided that the first clutch K1 is disengaged, in the forward gear steps V2, V3, and V4.

In FIG. 3, a gearshift table for two electric-motor gear steps E1.1 and E1.2 is represented, in which electric motor-generated input power is provided predominantly by the first electric machine 56. The first electric machine 56 is preferably designed as a main prime mover, whereas the second electric machine 60 can have a lower power.

In the first electric gear step E1.1, only the gearshift clutch A is engaged. All other shift elements are disengaged. When the separating clutch K0 is disengaged, the internal combustion engine 12 cannot deliver any power into the first input shaft 24. The second electric machine 60 cannot provide any additional input power, either, when the gearshift clutches B, C, D are disengaged.

A second electric gear step E1.2 is established when only the gearshift clutch E is engaged.

In the electric gear steps E1.1 and E1.2, however, it is possible to establish a serial operation, in which the separating clutch K0 is engaged and the internal combustion engine 12 drives the second electric machine 60 as a generator, in order to charge a vehicle battery, from which the first electric machine 56 withdraws input power.

Moreover, it is possible in the two forward gear steps E1.1 and E1.2 to provide additional electric motor-generated input power from the second electric machine 60, provided that the separating clutch K0 is disengaged and one of the gearshift clutches B, C, D is engaged. The first clutch K1 always remains disengaged in this case.

As described at the outset, all gear changes can take place in such a way that a synchronization can take place in advance by one or both electric machine(s), and so the gearshift clutches A, B, C, D, E and the first clutch K1 can also be designed as dog clutches without separate synchronization.

Moreover, all gear changes are implementable as powershifts, wherein, during gear shifts in the first sub-transmission 32, for example, a support of tractive force takes place via the first electric machine 56. During gear shifts in the second sub-transmission 34, a support of tractive force can be provided by the internal combustion engine 12 and/or the second electric machine 60.

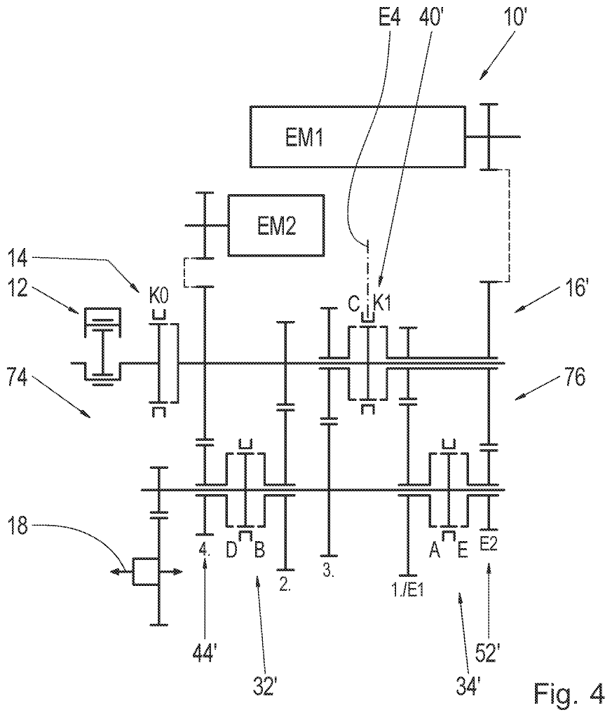

In the following FIGS. 4 through 7, further example embodiments of drive trains are represented, which generally correspond to the drive train 10 from FIG. 1 with regard to configuration and mode of operation. Identical elements are therefore labeled with identical reference characters. In the following, essentially, the differences are explained.

In the transmission arrangement 16′ of the drive train 10′ from FIG. 4, the axial arrangement of the two sub-transmissions 32′, 34′ is interchanged. The interchange is provided in such a way that a type of mirror imaging has taken place at the gearshift clutch plane E4. The gear set 52′ is now arranged closest to the second axial end 76. The gear set 44′ is now arranged closest to the first axial end 74.

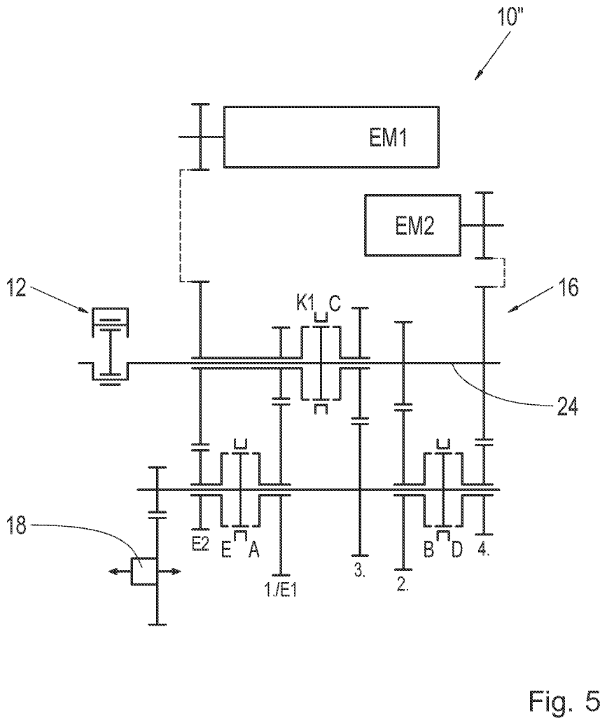

The drive train 10″ represented in FIG. 5 is based on the drive train 10 from FIG. 1, wherein a clutch assembly 14 is not provided, in such a way that the internal combustion engine 12 is rotationally fixed to the first input shaft 24.

In the drive train 10″ from FIG. 5, all functions as in the case of the drive train 10 from FIG. 1 are implementable, except for the possibility of a purely electric operation by the second electric machine 60 or a purely electric powershift between the gear steps E1.1 and E1.2.

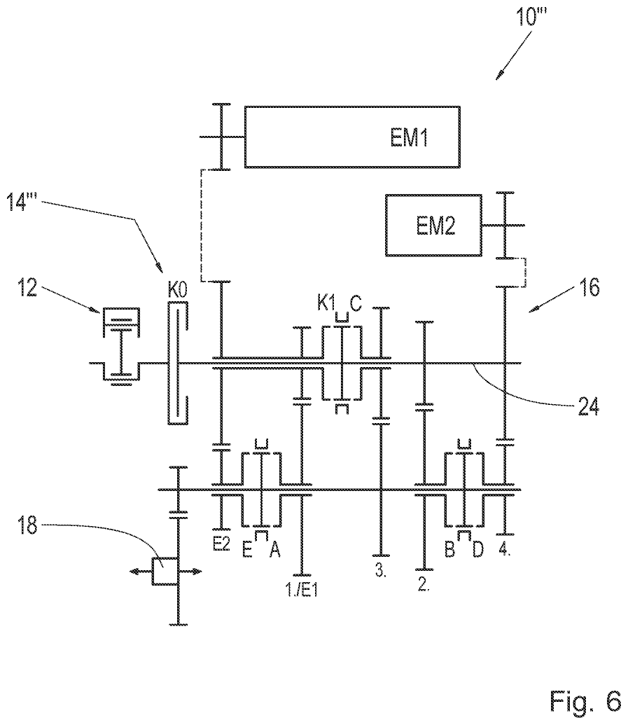

In the drive train 10′″ from FIG. 6, which is based on the drive train 10 from FIG. 1, the clutch assembly 14′″ now includes a friction clutch K0′″ instead of a dog clutch. The clutch K0′″ is generally not utilized for pulling away from rest in the case of the drive train 10′″ either, however, but rather is still utilized as a pure separating clutch, similarly to the separating clutch K0 of the drive train 10 from FIG. 1. In contrast, the friction clutch K0′″ can also disengage under load. Moreover, an engagement of the friction clutch K0′″ can also take place at a differential speed between the internal combustion engine 12 and the first input shaft 24.

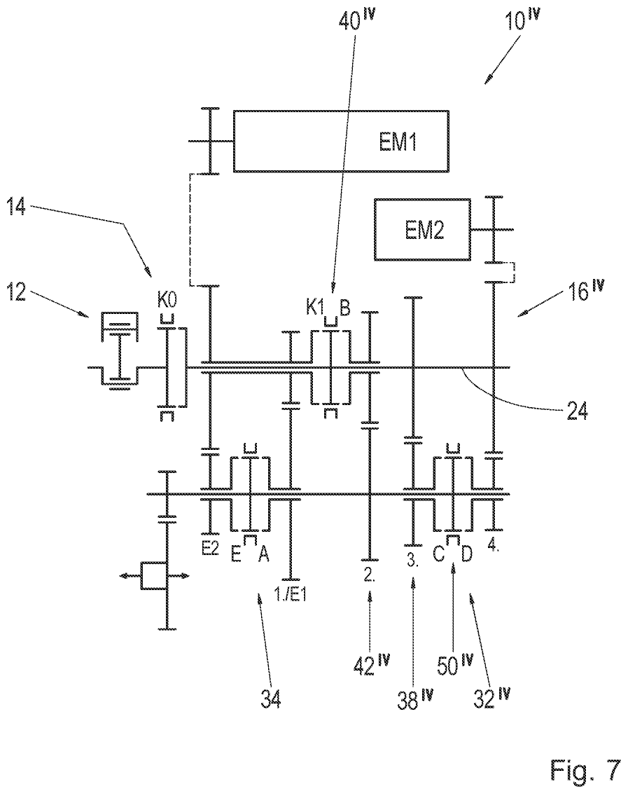

FIG. 7 shows a further drive train 10^{IV}, which is based on the drive train 10 from FIG. 1. In the drive train 10^{IV}, the gear sets for the second and third gear steps 2 and 3 are interchanged in the transmission arrangement 16^{IV}.

In this case, the gear set 42^{IV} is arranged adjacent to the first gearshift clutch assembly 40^{IV}, which, in this case, includes the first clutch K1 and the gearshift clutch B for the forward gear step 2.

On the other hand, the gear set 38^{IV} for the forward gear step 3 is now arranged in the axial direction between the gear set 42^{IV} and the second gearshift clutch assembly 50^{IV}. The second gearshift clutch assembly 50^{IV} of the first sub-transmission 32^{IV} includes the gearshift clutch C for the third forward gear step 3 and the gearshift clutch D for the fourth forward gear step 4.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 clutch assembly
16 hybrid transmission arrangement
18 power distribution unit
20 driven wheels
22 control device
24 first input shaft
26 second input shaft
28 output shaft
30 output gear set
32 first sub-transmission
34 second sub-transmission
36 gear set (1/E1)
38 gear set (3)
40 first gearshift clutch assembly
42 gear set (2)
44 gear set (4)
50 second gearshift clutch assembly
52 gear set (E2)
54 third gearshift clutch assembly
56 first electric machine
58 first pinion (first machine pinion)
59 first intermediate gear
60 second electric machine
62 second pinion (second machine pinion)
73 second intermediate gear
70 first gearwheel (first machine gearwheel)
72 second gearwheel (second machine gearwheel)
74 first axial end
76 second axial end
A1-A5 axes
A-E gearshift clutches for gear-step gear sets
K0 separating clutch
E1-E8 gear set and clutch planes
S1-S4 actuating units
P parking interlock gear

1.-15. (canceled)

16. A transmission arrangement (16) for a motor vehicle drive train (10), comprising:
a first input shaft (24) connected or connectable to an internal combustion engine (12);
a second input shaft (26) arranged coaxially to the first input shaft (24);
an output shaft connected to the first input shaft (24) via a plurality of engageable first gear-step gear sets (38, 42, 44) and connected to the second input shaft (26) via a plurality of engageable second gear-step gear sets (36, 52);
a first electric machine (56) connected to the second input shaft (26);
a second electric machine (60) connected to the first input shaft (24); and
a first clutch (K1) via which the first input shaft (24) and the second input shaft (26) are connectable to each other,
wherein the second gear-step gear sets comprises two alternately engageable gear-step gear sets (36, 52), via each of which an electric motor-driven operation is establishable by the first electric machine (56), and
wherein the transmission arrangement (16) is configured such that an internal combustion engine-driven operation is establishable via one (36) of the two alternately engageable gear-step gear sets (36, 52) when the first clutch (K1) is engaged.

17. The transmission arrangement of claim 16, wherein the first input shaft (24) is connected to the output shaft (28) via three of the engageable first gear-step gear sets (38, 42, 44).

18. The transmission arrangement of claim 16, wherein the two alternately engageable gear-step gear sets (36, 52) comprises a gear-step gear set (36) for a starting gear step, via which the internal combustion engine-driven operation is establishable.

19. The transmission arrangement of claim 16, wherein the other (52) of the two alternately engageable gear-step gear sets (36, 52) is associated with a second electric gear step (E1.2), and a ratio of the second electric gear step (E1.2) is less than a largest ratio of the first gear-step gear sets (38, 42, 44) and is greater than a smallest ratio of the first gear-step gear sets (38, 42, 44).

20. The transmission arrangement of claim 16, wherein the first clutch (K1) is arranged in an axial direction between the first gear-step gear sets (38, 42, 44) and the second gear-step gear sets (36, 52).

21. The transmission arrangement of claim 16, wherein the first clutch (K1) and a gearshift clutch (C; B) for engaging one (38; 42) of the first gear-step gear sets (38, 42, 44) form a first gearshift clutch assembly (40) actuatable by a single actuating unit (S1).

22. The transmission arrangement of claim 16, further comprising two gearshift clutches (B, D; C, D) that are configured for alternating engagement of two of the first gear-step gear sets (38, 44; 38, 44) and form a second gearshift clutch assembly (50).

23. The transmission arrangement of claim 16, further comprising two gearshift clutches (A, E) that are configured for alternating engagement of two of the second gear-step gear sets (36, 52) and form a third gearshift clutch assembly (54).

24. The transmission arrangement of claim 16, wherein the transmission arrangement comprises, axially one after the other starting from one axial end (74; 76):
a gear set plane (El) for a second gear step (E2) usable by an electric motor;
a gearshift clutch plane (E2) for a third gearshift clutch assembly (54);
a gear set plane (E3) for a first gear step (1);
a gearshift clutch plane (E4) for a first gearshift clutch assembly (40) that comprises the first clutch (K1);
a gear set plane for a third gear step (3) or for a second gear step (2);
a gear set plane (E6) for a second gear step (2) or a third gear step (3);
a gearshift clutch plane (E7) for a second gearshift clutch assembly (50); and
a gear set plane for a fourth gear step (4).

25. The transmission arrangement of claim 16, wherein the transmission arrangement includes an output gear set (30) at one axial end (74), by means of which the output shaft (28) is connected to a power distribution unit (18) for driven wheels (20L, 20R).

26. The transmission arrangement of claim 16, wherein:
the first electric machine (56) is connected to the second input shaft (26) via one (52) of the second gear-step gear sets (36, 52); or
the second electric machine (60) is connected to the first input shaft (24) via one (44) of the first gear-step gear sets (38, 42, 44); or
both the first electric machine (56) is connected to the second input shaft (26) via the one (52) of the second gear-step gear sets (36, 52) and the second electric machine (60) is connected to the first input shaft (24) via the one (44) of the first gear-step gear sets (38, 42, 44).

27. The transmission arrangement of claim 26, wherein:
one of the second gear-step gear sets (52), via which the first electric machine (56) is connected to the second input shaft (26), is arranged proximate a first axial end (74) of the transmission arrangement (16); or
one of the first gear-step gear sets (44), via which the second electric machine (60) is connected to the first input shaft (24), is arranged proximate a second axial end (76) of the transmission arrangement (16); or
both the one of the second gear-step gear sets (52), via which the first electric machine (56) is connected to the second input shaft (26), is arranged proximate the first axial end (74) of the transmission arrangement (16) and the one of the first gear-step gear sets (44), via which the second electric machine (60) is connected to the first input shaft (24), is arranged proximate the second axial end (76) of the transmission arrangement (16).

28. The transmission arrangement of claim 26, wherein:
one of the second gear-step gear sets (52), via which the first electric machine (56) is connected to the second input shaft (26), is associated with a highest gear step (E1.2) establishable by the second gear-step gear sets (36, 52); or
one of the first gear-step gear sets (44), via which the second electric machine (60) is connected to the first input shaft (24), is associated with a highest gear step (4) establishable by the first gear-step gear sets (38, 42, 44); or
both the one of the second gear-step gear sets (52), via which the first electric machine (56) is connected to the second input shaft (26), is associated with the highest gear step (E1.2) establishable by the second gear-step gear sets (36, 52) and the one of the first gear-step gear sets (44), via which the second electric machine (60) is connected to the first input shaft (24), is associated with the highest gear step (4) establishable by the first gear-step gear sets (38, 42, 44).

29. A drive train for a motor vehicle, comprising:
the internal combustion engine (12); and
the transmission arrangement of claim 16,
wherein the first input shaft (24) is rotationally fixed to the internal combustion engine, or the first input shaft (24) is connected to the internal combustion engine (12) via a separating clutch (K0).

30. A method for operating the drive train (10) of claim 29, comprising:
starting from a purely electric operation or a hybrid operation via the one (36) of the two alternately engageable gear-step gear sets (36, 52), the first clutch (K1) engaged, the internal combustion engine (12) rotationally fixed to the first input shaft (24), and a gearshift clutch (A) associated with the one (36) of the two alternately engageable gear-step gear sets (36, 52);
reducing load at the first clutch (K1) and building up load at the first electric machine (56);
disengaging the first clutch (K1);
reducing a rotational speed of the first input shaft (24) until a further gearshift clutch (B) associated with one of the first gear-step gear sets is synchronized; and
engaging the further gearshift clutch (B).
